(19) United States
(12) Patent Application Publication
(10) Pub. No.: US 2014/0019224 A1
(43) Pub. Date: Jan. 16, 2014

(54) FACILITATING CONSUMER ACTIVITY THROUGH AN ELECTRONIC CARD DEVICE

(71) Applicants: SERGIO DE ACHA, San Jose, CA (US); Vivek S. Pendharkar, Los Altos Hills, CA (US); Michael Quinn, Berkeley, CA (US); Tamil Vengan, San Jose, CA (US); Prashant Kanhere, Cupertino, CA (US); Murali Chirala, Morgan Hill, CA (US); Derek Kumar, San Jose, CA (US)

(72) Inventors: SERGIO DE ACHA, San Jose, CA (US); Vivek S. Pendharkar, Los Altos Hills, CA (US); Michael Quinn, Berkeley, CA (US); Tamil Vengan, San Jose, CA (US); Prashant Kanhere, Cupertino, CA (US); Murali Chirala, Morgan Hill, CA (US); Derek Kumar, San Jose, CA (US)

(73) Assignee: Vu Cast Media Inc, Palo Alto, CA (US)

(21) Appl. No.: 13/545,047

(22) Filed: Jul. 10, 2012

(51) Int. Cl. G06Q 20/34; G06Q 20/32; G06Q 40/00; G06Q 20/40; G06K 19/073; G06Q 30/02

(52) U.S. Cl. 705/14.38; 235/492; 705/14.66; 705/35; 705/41

(57) ABSTRACT

An electronic card device includes a Radio Frequency (RF) circuit configured to receive information from a remote broadcast transmitter, a memory associated with the RF circuit to store a unique identifier of the electronic card device, and a processor communicatively coupled to the memory. The processor is configured to enable reception of the information from the remote broadcast transmitter based on the unique identifier of the electronic card device in the memory to generate data configured to facilitate consumer activity on part of a user of the electronic card device through the electronic card device. Also, the electronic card device includes a display unit integrated therewith configured to display output data related to the data generated through the processor.

### FIELD OF TECHNOLOGY

This disclosure relates generally to electronic card devices and, more particularly, to a method, an apparatus and/or a system of facilitating consumer activity through an electronic card device.

### BACKGROUND

A physical card (e.g., a business card, a credit card, a debit card, a coupon) may provide requisite means for an individual to communicate information to another entity (e.g., another individual, a merchant). For example, the aforementioned physical card may be carried by the individual in a wallet thereof. However, the physical card may be limited in an ability to have relevant information thereon with change in time (e.g., the individual may change his/her residential address, the credit card may expire). As the physical card is created and set in a material such as paper or plastic, the physical card may not include dynamic information accessible therethrough. Thus, the physical card may lose relevance with progress in time from an initial issuance thereof.

### SUMMARY

Disclosed are methods, an apparatus and/or a system of facilitating consumer activity through an electronic card device.

In one aspect, an electronic card device includes a Radio Frequency (RF) circuit configured to receive information from a remote broadcast transmitter, a memory associated with the RF circuit to store a unique identifier of the electronic card device, and a processor communicatively coupled to the memory. The processor is configured to enable reception of the information from the remote broadcast transmitter based on the unique identifier of the electronic card device in the memory to generate data configured to facilitate consumer activity on part of a user of the electronic card device through the electronic card device. Also, the electronic card device includes a display unit integrated therewith configured to display output data related to the data generated through the processor.

In another aspect, a consumer activity facilitation system includes a broadcast server having a broadcast transmitter associated therewith and an electronic card device including an RF circuit configured to receive information from the broadcast transmitter, a memory associated with the RF circuit to store a unique identifier of the electronic card device, and a processor communicatively coupled to the memory. The processor of the electronic card device is configured to enable reception of the information from the broadcast transmitter based on the unique identifier of the electronic card device in the memory to generate data configured to facilitate consumer activity on part of a user of the electronic card device through the electronic card device.

The consumer activity facilitation system also includes a network, and a distribution server coupled to the broadcast server through the network. The distribution server is configured to communicate the information to the broadcast server.

In yet another aspect, a method includes receiving, through an RF circuit of an electronic card device, information from a remote broadcast transmitter, and enabling reception of the information through a processor of the electronic card device based on a unique identifier thereof to facilitate consumer activity on part of a user of the electronic card device through the electronic card device based on the information. The method also includes rendering output data related to the information on a display unit integrated with the electronic card device.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of an electronic card device, according to one or more embodiments.

FIG. 2 is a schematic of an example scenario of the electronic card device of FIG. 1 interacting with an advertising network.

FIG. 3 is a schematic of an example scenario of a registered user associated with the electronic card device of FIG. 1 transacting with a merchant using a coupon.

FIG. 4 is an illustrative view of an example social network profile of a connection of the registered user associated with the electronic card device of FIG. 1.

FIG. 5 is a schematic view of the electronic card device of FIG. 1 in an example scenario of the registered user being associated with a banking network.

FIG. 6 is a schematic view of banking data of the registered user being displayed on a display unit of the electronic card device of FIG. 1.

FIG. 7 is a schematic view of another embodiment of the electronic card device of FIG. 1 including a near-field communication (NFC) circuit.

FIG. 8 is a schematic view of a consumer activity facilitation system including the electronic card device of FIG. 1, according to one or more embodiments.

FIG. 9 is a process flow diagram detailing the operations involved in a method of facilitating consumer activity through the electronic card device of FIG. 1, according to one or more embodiments.

Other features of the present embodiments will be apparent from the accompanying drawings and from the detailed description that follows.

### DETAILED DESCRIPTION

Example embodiments, as described below, may be used to provide a method, a system and/or an apparatus of facilitating consumer activity through an electronic card device. Although the present embodiments have been described with reference to specific example embodiments, it will be evident that various modifications and changes may be made to these embodiments without departing from the broader spirit and scope of the various embodiments.

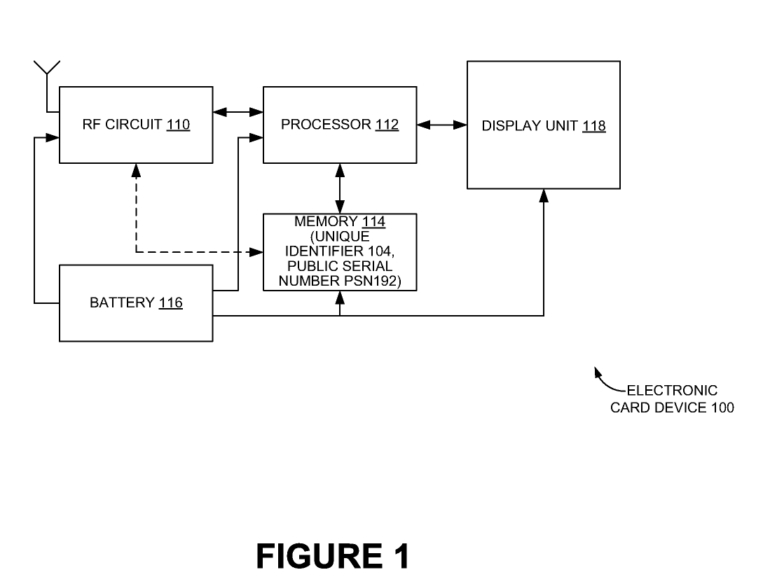

FIG. 1 shows an electronic card device 100, according to one or more embodiments. In one or more embodiments, electronic card device 100 may include a Radio Frequency (RF) circuit 110 configured to receive information from a remote broadcaster (not shown in FIG. 1). In one or more embodiments, electronic card device 100 may include a processor 112 communicatively coupled to a memory 114, with processor 112 being configured to execute instructions associated with one or more functionalities provided through electronic card device 100. In one or more embodiments, processor 112 and/or memory 114 may be associated with RF circuit 110 either by being part of a same chip as RF circuit 110 or by being external thereto. FIG. 1 shows processor 112 and memory 114 as being external to RF circuit 110 merely for the sake of illustrative elegance.

In one or more embodiments, memory 114 may include a Random Access Memory (RAM), Read-Only Memory (ROM; e.g., Electrically Erasable Programmable ROM (EEPROM)) and/or a flash memory. In one or more embodiments, RF circuit 110 may include an integrated circuit (IC) embedded in a medium of thin film. In one or more embodiments, information stored in memory 114 may be transmitted through an antenna (not shown) embedded in RF circuit 110 to an appropriate reader device (not shown). In one or more embodiments, RF circuit 110 may have a power source associated therewith in the form of a battery 116. In one or more embodiments, RF circuit 110 may transmit data in the form of a signal when read through the reader device. In one or more embodiments, power may neither be provided to RF circuit 110 through inductive coupling nor through capacitive coupling, but may be provided solely through battery 116. In one or more embodiments, battery 116 may also be the power source for memory 114 and/or processor 112.

One of ordinary skill in the art would be familiar with the details and example implementation(s) of an RF circuit 110 and, therefore, RF circuit 110 is not shown in detail in FIG. 1 or in any of the other figures to be discussed herein for the sake of brevity and convenience. In one or more embodiments, electronic card device 100 may have a unique identifier 104 associated therewith. For example, unique identifier 104 may be programmed (e.g., hard-coded into a databank) into memory 114. FIG. 1 shows unique identifier 104 as part of memory 114.

In one or more embodiments, when RF circuit 110 receives encrypted data from a remote broadcast transmitter (not shown in FIG. 1), processor 112 may be configured to decrypt (e.g., based on a decryption algorithm; instructions associated with the decryption algorithm may be stored in memory 114) the encrypted data using unique identifier 104 of electronic card device 100. In one or more embodiments, electronic card device 100 may include a display unit 118 integrated with electronic card device 100 (e.g., in a housing thereof) configured to display an output associated with the decrypted data for viewing.

In one or more embodiments, memory 114 of electronic card device 100 may also include a public serial number (PSN 192 shown as being part of memory 114) configured to associate electronic card device 100 with a registered user of a banking network and/or an advertising network. It is to be noted that while encrypted data is shown as being received by RF circuit 110, unencrypted broadcast data may also be received therethrough. While exemplary embodiments discussed herein preferentially are directed to the banking network and the advertising network discussed below where encryption may be required, electronic card device 100 may receive unencrypted data in one or more embodiments. Here, electronic card device 100 may still make sure that the data is addressed thereto based on unique identifier 104 without any involvement of decryption thereof.

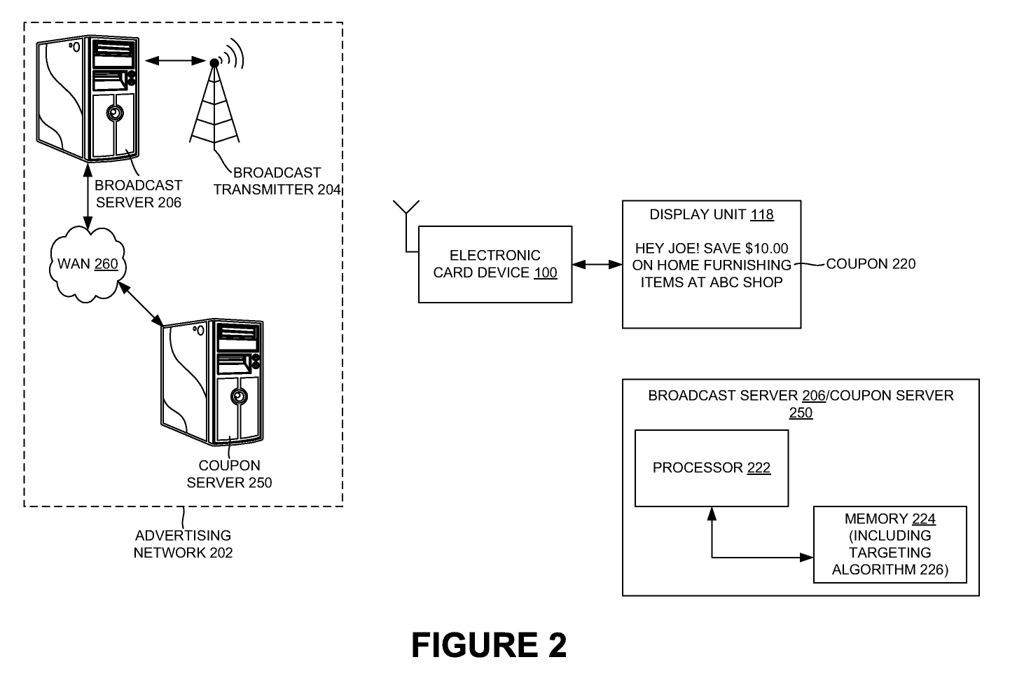

FIG. 2 shows an example scenario of electronic card device 100 interacting with advertising network 202. In one or more embodiments, broadcast transmitter 204 associated with a broadcast server 206 may be configured to transmit an encrypted version of a coupon 220 (and/or an offer, a promotion) to electronic card device 100. In one or more embodiments, the aforementioned broadcast server 206 and broadcast transmitter 204 may be part of advertising network 202.

In one or more embodiments, upon receipt of the encrypted version of coupon 220, electronic card device 100 may decrypt coupon 220 through processor 112 and display unit 118 may display coupon 220. In one or more embodiments, coupon 220 may be associated with a targeted advertisement based on a characteristic of the registered user (e.g., a registered profile) of advertising network 202. FIG. 2 shows display unit 118 displaying text associated with coupon 220. In one or more embodiments, coupon 220 may actually be generated by coupon server 250 communicatively coupled to broadcast server 206 through a computer network (e.g., Wide Area Network (WAN) 260). Thus, in one or more embodiments, the aforementioned broadcast server 206, broadcast transmitter 204 and coupon server 250 may be part of advertising network 202.

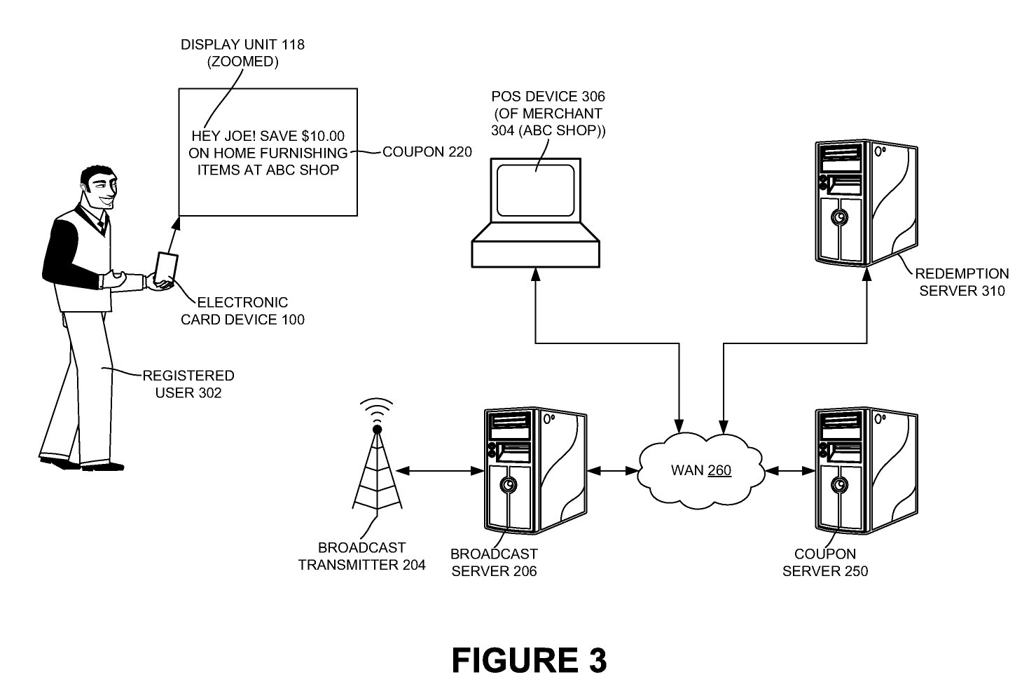

FIG. 3 shows an example scenario of a registered user 302 transacting with a merchant 304 using coupon 220. Registered user 302 may purchase items at, say, a supermarket (example merchant 304), following which he/she proceeds to pay at a Point-Of-Sale (POS) device 306 at the supermarket. Now coupon server 250 may receive a notification from a redemption server 310 associated with POS device 306 that registered user 302 has entered into a transaction with merchant 304 using coupon 220. For example, coupon 220 may have been transmitted to electronic card device 100 associated with registered user 302 after registered user 302 completes a first transaction with merchant 304 or when registered user 302 completes a questionnaire from merchant 304. Alternately, coupon 220 may have been obtained by registered user 302 through a postal service or e-mail, and the transmission of coupon 220 to electronic card device 100 may be in addition to the aforementioned procurement. Other forms of procuring coupon 220 are within the scope of the exemplary embodiments.

Following receipt of the notification from redemption server 310, coupon 220 may be validated/authenticated at coupon server 250 to determine whether registered user 302 is associated with coupon 220. After successful authentication, registered user 302 may be provided the benefits associated with coupon 220 (e.g., a bill incorporating discount(s) associated with coupon 220) through POS device 306.

In one or more embodiments, broadcast server 206 may periodically communicate data associated with a targeted coupon to registered user 302 as the encrypted data (e.g., through broadcast transmitter 204). FIG. 2 also shows broadcast server 206 (and/or coupon server 250) as including a processor 222 communicatively coupled to a memory 224. In one or more embodiments, processor 222 may execute instructions associated with a targeting algorithm 226 to generate data associated with the targeted coupon. In one or more embodiments, instructions associated with targeting algorithm 226 may be stored in memory 224.

In the example scenario discussed in FIG. 3, targeting algorithm 226 may incorporate the transaction of registered user 302 as an input to determine a preference characteristic of registered user 302. For example, registered user 302 may have purchased a number of home furnishing items from the supermarket and, therefore, the data associated with the targeted coupon may be associated with discounts on home furnishing items. As shown in FIGS. 2-3, display unit 118 displays “Hey Joe! Save $10.00 on home furnishing items at ABC shop” as an example coupon 220 text.

In one or more embodiments, the targeting algorithm may also incorporate other parameters as input such as a profile of registered user 302 in a social network (e.g., Facebook®), an interest expressed by registered user 302 in the social network and a social transaction characteristic based on connections of registered user 302 with other users of the social network. For example, the social transaction characteristic may be a collective preference of registered user 302 and connections thereof in the social network. For example, a majority of registered user 302 and connections thereof may be a fan of a particular football team.

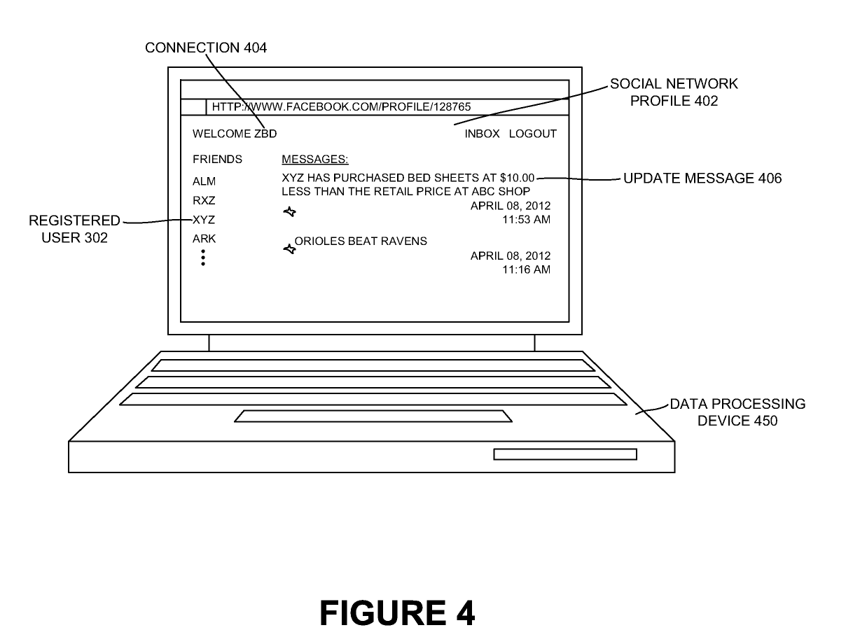

In one or more embodiments, a transaction between registered user 302 and merchant 304 involving coupon 220 may be publicized by coupon server 250 with the connections of registered user 302, thereby apprising the connections with offers availed by registered user 302. FIG. 4 shows an example social network profile 402 of a connection 404 of registered user 302 on a data processing device 450. The social network profile 402 of connection 404 shows an update message 406 reading “XYZ has purchased bed sheets at $10.00 less than the retail price at ABC shop.” XYZ here is registered user 302 and ABC shop is merchant 304. Other implementations of update message 406 are within the scope of the exemplary embodiments.

In one or more embodiments, coupon server 250/broadcast server 206 may enable compatibility of a social network platform therewith. Thus, in one or more embodiments, registered user 302 may log into a page associated with coupon server 250 using the social network platform, thereby providing for the social networking details thereof to be an input to the targeting algorithm.

In an example embodiment, POS device 306 may scan a barcode or a Quick Response (QR) code displayed as decrypted data on display unit 118 of electronic card device 100 to validate at least a portion of the transaction.

While exemplary embodiments discussed with reference to advertising network 202 refer to coupon 220, it is obvious that broadcast server 206 may also transmit offers, promotions et al. to electronic card device 100. In an example embodiment, electronic card device 100 may be linked with one or more bank offers. All of the aforementioned promotions, offers and coupons 220 are within the scope of the exemplary embodiments.

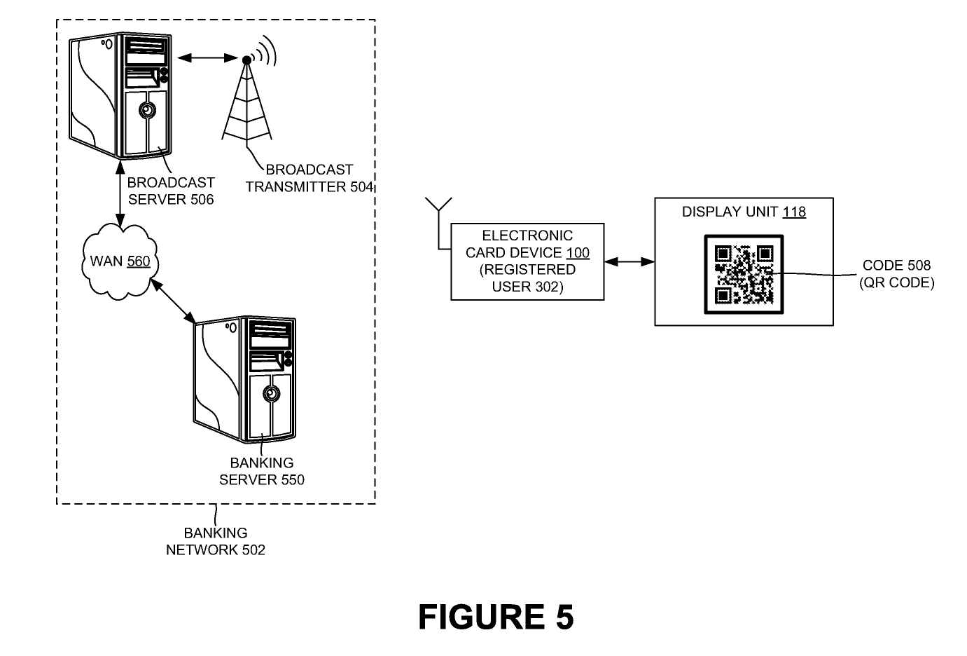

FIG. 5 shows electronic card device 100 in an example scenario of registered user 302 being associated with a banking network 502. FIG. 5 shows broadcast transmitter 504 (analogous to broadcast transmitter 204) associated with a broadcast server 506 (analogous to broadcast server 206) configured to transmit an encrypted version of a code 508 to electronic card device 100. In one or more embodiments, the aforementioned broadcast server 506 and broadcast transmitter 504 may be part of banking network 502.

In one or more embodiments, upon receipt of the encrypted version of code 508, electronic card device 100 may decrypt code 508 through processor 112 and display unit 118 may display code 508 (e.g., a barcode, a QR code; QR code is shown as an example in FIG. 5). In one or more embodiments, code 508 may be associated with a secondary authentication process of a banking function of registered user 302 of banking network 502. In one or more embodiments, code 508 may actually be generated by banking server 550 communicatively coupled to broadcast server 506 through a computer network (e.g., WAN 560 analogous to WAN 260). Thus, in one or more embodiments, the aforementioned broadcast server 506, broadcast transmitter 504 and banking server 550 may be part of banking network 502.

As shown in FIG. 5, banking server 550 may be configured to communicate with broadcast server 506 through WAN 560. For example, WAN 560 may be the Internet. In one or more embodiments, automatic update(s) of the aforementioned code 508 may be scheduled by banking server 550 through broadcast transmitter 504 for security purposes. For example, code 508 may be updated periodically (e.g., every 24 hours) or with every successful completion of the secondary authentication process of the banking function using code 508.

In one or more embodiments, display unit 118 of electronic card device 100 may be configured to automatically display banking data of registered user 302 as the decrypted data upon receipt of a valid encrypted data from broadcast transmitter 504. Here, in one or more embodiments, RF circuit 110 may function as a transmitter (RF circuit 110 may be a transceiver instead of merely being a receiver; in other words, RF circuit may have both transmitter and receiver capabilities) circuit that transmits a request for banking data to banking server 550. Registered user 302, for example, may initiate the request through an appropriate touch button displayed on display unit 118. Other forms of initiating the request are within the scope of the exemplary embodiments.

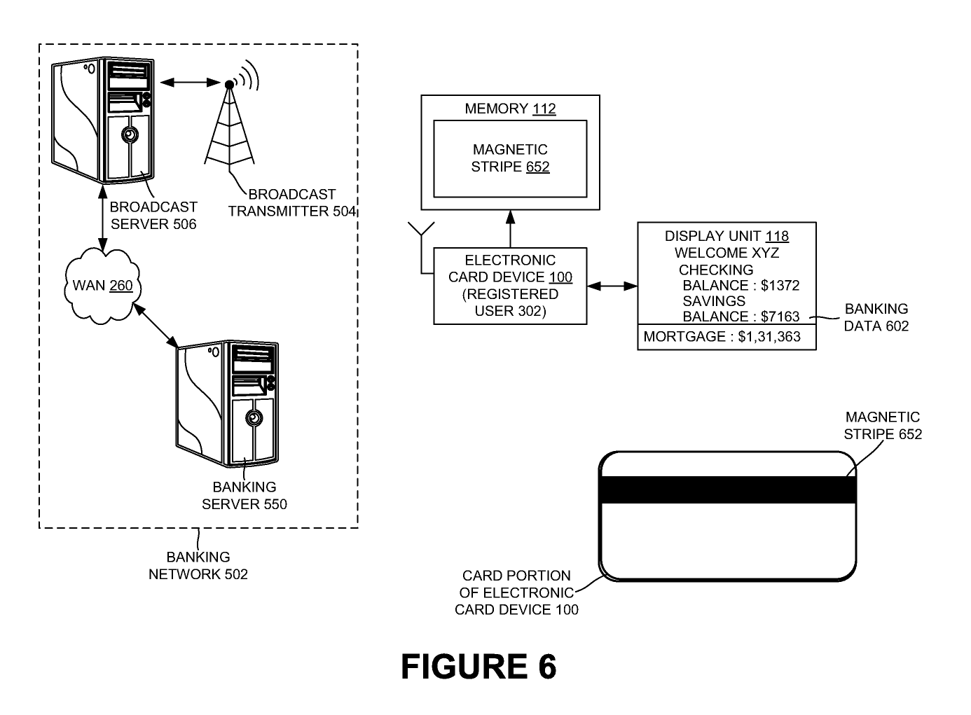

FIG. 6 shows banking data 602 of registered user 302 being displayed on display unit 118 of electronic card device 100. In one or more embodiments, banking data 602 may be a financial data of registered user 302 of banking network 502. In one or more embodiments, banking data 602 may include account information, balance data, transaction data and usage data of registered user 302. FIG. 6 shows checking account balance and savings account balance of an example registered user 302, viz. XYZ, along with the balance mortgage amount due.

In one or more embodiments, banking server 550 may schedule automatic and periodic update(s) of banking data 602 through broadcast transmitter 504 to enable registered user 302 to view the accurate version of banking data 602. In one or more embodiments, electronic card device 100 may include a magnetic stripe 652 (shown as part of memory 112 for illustrative clarity) to store information associated with registered user 302 of banking network 502 such as credit/debit/payment card data to be used during payment for purchases through a merchant (e.g., merchant 304). Alternately, the credit/debit/payment card data may be stored in memory 112 and merely transmitted in a decrypted form through magnetic stripe 652. For example, banking server 550 may transmit encrypted information associated with the credit/debit/payment card data through broadcast transmitter 504 when requested by registered user 302, which is then stored (e.g., in decrypted form, as it is) in memory 112. The aforementioned credit/debit/payment card data may then be transmitted in decrypted form thereof through magnetic stripe 652 during a transaction with a merchant.

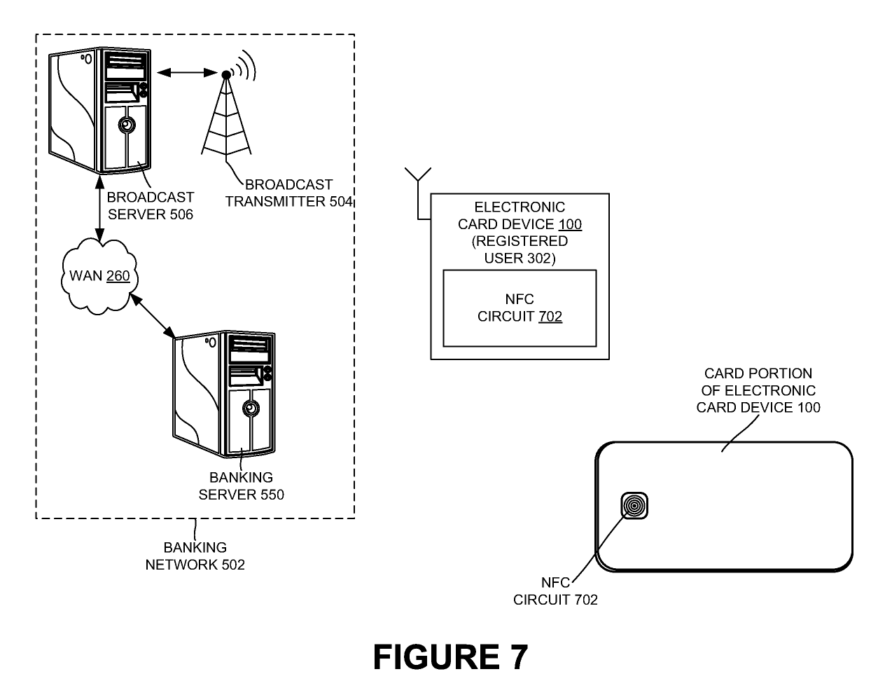

It is obvious that the credit/debit/payment card data may include a card number, a security identifier, owner name, billing address and/or expiration date. FIG. 6 also shows a perspective view of the card portion of electronic card device 100 including magnetic stripe 652. FIG. 7 shows an alternate embodiment of electronic card device 100 including a near-field communication (NFC) circuit 702 configured to be read by an appropriate reader device. In one or more embodiments, NFC circuit 702 may be an NFC tag that is programmed with the aforementioned credit/debit/payment card data, which is configured to be read by an appropriate reader device of the merchant (e.g., merchant 304). Alternately, the credit/debit/payment data may be stored in memory 112, and then transmitted in decrypted form through NFC circuit 702 when read by the appropriate reader device. In one or more embodiments, NFC circuit 702 may also be utilized to redeem offers, promotions and coupons (e.g., coupon 220).

In one or more embodiments, NFC circuit 702 may further be utilized to receive data from other NFC-enabled devices such as (but not limited to) POS terminals. The aforementioned data may be offer data, coupon data and/or promotional data and the like.

In FIGS. 1-7, banking server 550 and coupon server 250 are example distribution server(s) configured to transmit encrypted data to broadcast server (206, 506). In an alternate embodiment, a one-time password (OTP) server (for user authentication, for example; not shown in FIGS. 1-7) may also be an example distribution server. Other example distribution servers configured to transmit encrypted data associated with consumer (e.g., registered user 302) activity facilitation are within the scope of the exemplary embodiments discussed herein.

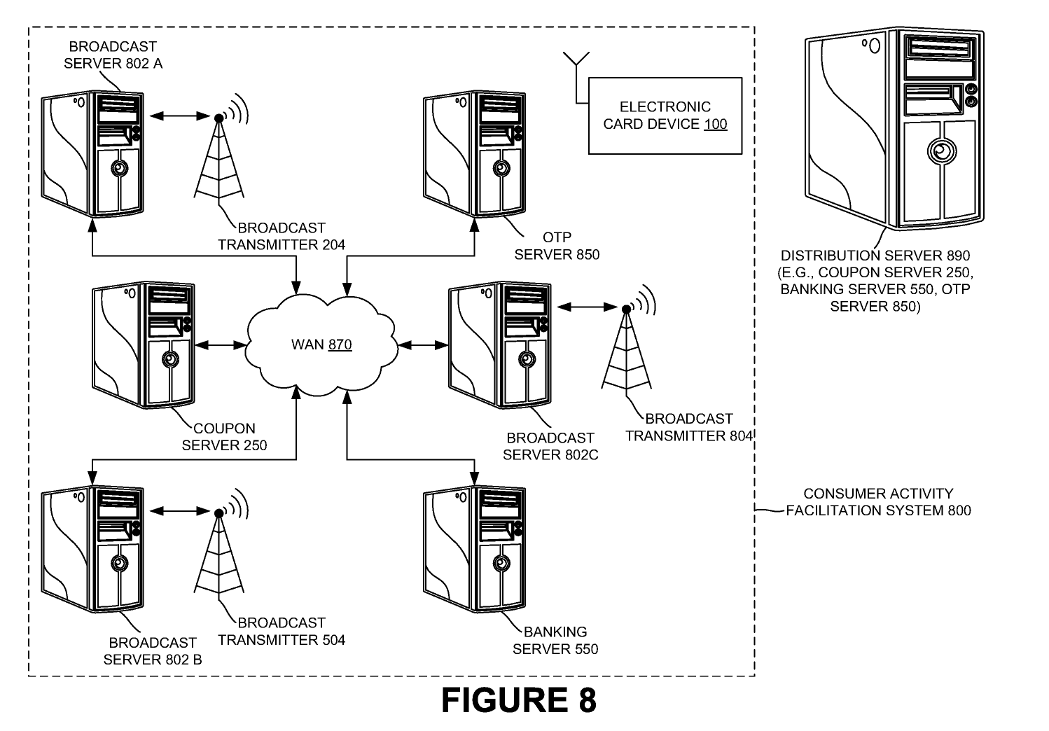

FIG. 8 shows consumer activity facilitation system 800, according to one or more embodiments. FIG. 8 shows consumer activity facilitation system 800 as including electronic card device 100 configured to communicate with coupon server 250, banking server 550 and/or OTP server 850 through appropriate broadcast servers 802 A-C (802 A being associated with coupon server 250, 802 B being associated with banking server 550, and 802 C being associated with OTP server 850) and broadcast transmitters (204, 504, 804; 804 is associated with broadcast server 802 C). Although FIG. 8 shows each of coupon server 250, banking server 550 and OTP server 850 as being associated with a distinct broadcast server 802 A-C and a broadcast transmitter (204, 504, 804), it is obvious that the same broadcast transmitter (204, 504, 804) may be employed in conjunction with a number of servers. In FIG. 8, coupon server 250, banking server 550 and OTP server 850 are collectively referred to as distribution server(s) 890. Also, FIG. 8 shows each of coupon server 250, banking server 550 and OTP server 850 as being coupled to the appropriate broadcast server through WAN 870 (analogous to WAN 260 and WAN 560).

Thus, in one or more embodiments, exemplary embodiments discussed herein may facilitate consumer activity through the capabilities of electronic card device 100, thereby circumventing issues associated with the irrelevance and obsoleteness of physical cards such as business cards, coupons and credit/debit cards.

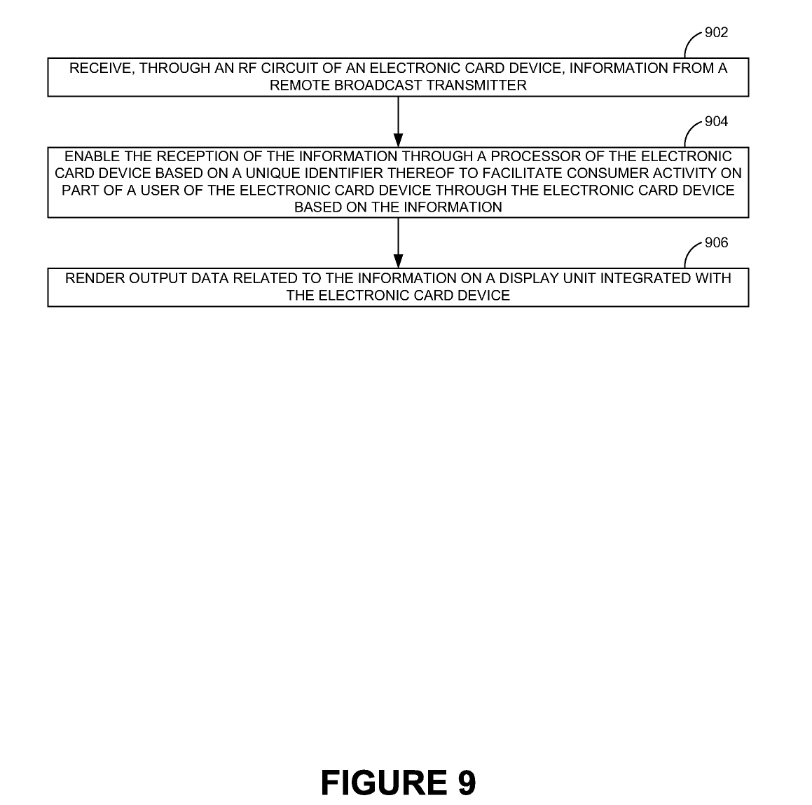

FIG. 9 shows a process flow diagram detailing the operations involved in a method of facilitating consumer activity through electronic card device 100, according to one or more embodiments. In one or more embodiments, operation 902 may involve receiving, through RF circuit 110 of electronic card device 100, encrypted information from a remote broadcast transmitter (204, 504, 804). In one or more embodiments, operation 904 may involve decrypting, through processor 112 of electronic card device 100, the encrypted information received by electronic card device 100 based on a unique identifier 104 thereof to facilitate consumer activity on part of a user (e.g., registered user 302) of electronic card device 100 through electronic card device 100 based on the decrypted information.

In one or more embodiments, operation 906 may then involve rendering output data related to the decrypted information on display unit 118 integrated with electronic card device 100.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer device). Accordingly, the specification and drawings are to be regarded in an illustrative rather than a restrictive sense.

What is claimed is:

1. An electronic card device comprising:
a Radio Frequency (RF) circuit configured to receive information from a remote broadcast transmitter;
a memory associated with the RF circuit to store a unique identifier of the electronic card device therein;
a processor communicatively coupled to the memory, the processor being configured to enable reception of the information from the remote broadcast transmitter based on the unique identifier of the electronic card device in the memory to generate data configured to facilitate consumer activity on part of a user of the electronic card device through the electronic card device; and
a display unit integrated with the electronic card device configured to display output data related to the data generated through the processor.

2. The electronic card device of claim 1, wherein at least one of:
the RF circuit is configured to receive encrypted data as the information from the remote broadcast transmitter,
the processor is configured to decrypt the encrypted data received by the RF circuit based on the unique identifier of the electronic card device,
the memory further comprises a public serial number configured to associate the electronic card device with a registered profile of the user on at least one of: an advertising network and a banking network, and
the RF circuit is one of: an RF receiver circuit and an RF transceiver circuit.

3. The electronic card device of claim 2,
wherein the display unit is configured to automatically display at least one of a coupon, a promotion and an offer as the output data, the at least one of the coupon, the promotion and the offer being associated with a targeted advertisement based on a characteristic of the registered profile on the advertising network, and the at least one of the coupon, the promotion and the offer being generated by a coupon server configured to transmit an encrypted version thereof to the electronic card device through a broadcast server associated with the broadcast transmitter.

4. The electronic card device of claim 2,
wherein the display unit is configured to automatically display a code as the output data, the code being associated with a secondary authentication process of a banking function associated with the registered profile on the banking network, and the code being generated by a banking server configured to transmit an encrypted version thereof to the electronic card device through a broadcast server associated with the broadcast transmitter.

5. The electronic card device of claim 2,
wherein the display unit is automatically configured to display banking data as the output data, the banking data being financial data associated with the registered profile on the banking network, and the banking data including at least one of: account information, balance data, transaction data and a usage data associated with the registered profile.

6. The electronic card device of claim 2, further comprising a magnetic stripe to communicate a payment card data associated with the registered profile on the banking network to a merchant, the payment card data being configured to be stored in an encrypted form thereof in the memory and transmitted in a decrypted form thereof through the magnetic stripe, and the payment card data including at least one of a card number, a security identifier, an owner name, a billing address and an expiration date.

7. The electronic card device of claim 2, further comprising a near-field communication (NFC) circuit to communicate a payment card data associated with the registered profile on the banking network to merchant, the payment card data being configured to be stored in an encrypted form thereof in the memory and transmitted in a decrypted form thereof through the NFC circuit, and the payment card data including at least one of a card number, a security identifier, an owner name, a billing address and an expiration date.

8. The electronic card device of claim 7, wherein the NFC circuit is capable of redeeming at least one of an offer, a coupon and a promotion at a point-of-sale terminal.

9. A consumer activity facilitation system comprising:
a broadcast server having a broadcast transmitter associated therewith;
an electronic card device comprising:
an RF circuit configured to receive information from the broadcast transmitter;
a memory associated with the RF circuit to store a unique identifier of the electronic card device therein; and
a processor communicatively coupled to the memory, the processor being configured to enable reception of the information from the broadcast transmitter based on the unique identifier of the electronic card device in the memory to generate data configured to facilitate consumer activity on part of a user of the electronic card device through the electronic card device;
a network; and
a distribution server coupled to the broadcast server through the network, the distribution server being configured to communicate the information to the broadcast server.

10. The consumer activity facilitation system of claim 9, wherein the distribution server includes at least one of: a coupon server, a banking server and a one-time password (OTP) server.

11. The consumer activity facilitation system of claim 10, wherein at least one of:
the RF circuit is configured to receive encrypted data as the information from the broadcast transmitter,
the processor is configured to decrypt the encrypted data received by the RF circuit based on the unique identifier of the electronic card device,
the memory of the electronic card device further includes a public serial number configured to associate the electronic card device with a registered profile of the user on at least one of: an advertising network including the coupon server and a banking network including the banking server, and
wherein the electronic card device further comprises a display unit integrated therewith configured to display output data related to the data generated through the processor thereof.

12. The consumer activity facilitation system of claim 11, wherein at least one of:
the display unit of the electronic card device is configured to automatically display at least one of a coupon, a promotion and an offer as the output data, the at least one of the coupon, the promotion and the offer being associated with a targeted advertisement based on a characteristic of the registered profile on the advertising network, and the at least one of the coupon, the promotion and the offer being generated by the coupon server configured to transmit an encrypted version thereof to the electronic card device through the broadcast server,
the consumer activity facilitation system further comprises a redemption server associated with a point-of-sale device of a merchant with which the user is configured to enter into a transaction using the coupon,
the broadcast server is configured to periodically communicate data associated with a targeted at least one of a coupon, a promotion and an offer to the electronic card device as the encrypted information based on a targeting algorithm,
the targeting algorithm is configured to incorporate as input at least one of: the transaction, the registered profile, an interest of the user as expressed in a social network and a social transaction characteristic based on connections of the user with other users of the social network in determining a preference characteristic of the user,
the coupon server is configured to publicize the transaction with connections of the user in the social network, and
the point-of-sale device is configured to scan at least one of: a barcode and a Quick Response (QR) code displayed as the output data on the display unit of the electronic card device.

13. The consumer activity facilitation system of claim 11, wherein at least one of:
the display unit of the electronic card device is configured to automatically display a code as the output data, the code being associated with a secondary authentication process of a banking function associated with the registered profile on the banking network, and the code being generated by the banking server configured to transmit an encrypted version thereof to the electronic card device through the broadcast server, and
the banking server is configured to schedule an automatic update of the code through the broadcast transmitter of the broadcast server at least one of: after the code is used by the user in the secondary authentication process of the banking function and periodically.

14. The consumer activity facilitation system of claim 11, wherein at least one of:
the display unit of the electronic card device is automatically configured to display banking data as the output data, the banking data being financial data associated with the registered profile on the banking network, and the banking data including at least one of: account information, balance data, transaction data and a usage data associated with the registered profile, and
the banking server is configured to schedule an automatic update of the banking data through the broadcast server periodically.

15. A method comprising:
receiving, through an RF circuit of an electronic card device, information from a remote broadcast transmitter;
enabling reception of the information through a processor of the electronic card device based on a unique identifier thereof to facilitate consumer activity on part of a user of the electronic card device through the electronic card device based on the information; and
rendering output data related to the information on a display unit integrated with the electronic card device.

16. The method of claim 15, further comprising:
associating the electronic card device with a registered profile of the user on at least one of: an advertising network and a banking network through a public serial number in a memory of the electronic card device.

17. The method of claim 16, comprising:
automatically displaying on the display unit at least one of an offer, a promotion and a coupon as the output data, the at least one of the offer, the promotion and the coupon being associated with a targeted advertisement based on a characteristic of the registered profile on the advertising network, and the at least one of the offer, the promotion and the coupon being generated by a coupon server configured to transmit an encrypted version thereof to the electronic card device through a broadcast server associated with the broadcast transmitter.

18. The method of claim 16, comprising:
automatically displaying on the display unit a code as the output data, the code being associated with a secondary authentication process of a banking function associated with the registered profile on the banking network, and the code being generated by a banking server configured to transmit an encrypted version thereof to the electronic card device through a broadcast server associated with the broadcast transmitter.

19. The method of claim 16, comprising:
automatically displaying on the display unit banking data as the output data, the banking data being financial data associated with the registered profile on the banking network, and the banking data including at least one of: account information, balance data, transaction data and a usage data associated with the registered profile.

20. The method of claim 16, further comprising:
storing payment data associated with the registered profile on the banking network in the memory in an encrypted form thereof; and
transmitting the payment card data associated with the registered profile on the banking network in a decrypted form thereof to a merchant through a magnetic stripe on the electronic card device, the payment card data including at least one of a card number, a security identifier, an owner name, a billing address and an expiration date.

21. The method of claim 16, further comprising:
storing payment data associated with the registered profile on the banking network in the memory in an encrypted form thereof; and
transmitting the payment card data associated with the registered profile on the banking network in a decrypted form thereof to a merchant through an NFC circuit on the electronic card device, the payment card data including at least one of a card number, a security identifier, an owner name, a billing address and an expiration date.
